(19) United States
(12) Patent Application Publication
(10) Pub. No.: US 2020/0094459 A1
(43) Pub. Date: Mar. 26, 2020

(54) LIQUID SILICONE MOLDING DIE

(71) Applicant: RAYSPERT PRECISION INDUSTRIAL INC., Tainan (TW)

(72) Inventors: Shun-Fu Lin, Tainan (TW); Yu-Chang Su, Tainan (TW)

(21) Appl. No.: 16/554,627

(22) Filed: Aug. 29, 2019

(30) Foreign Application Priority Data
Sep. 26, 2018 (TW) 1071133908

(51) Int. Cl. B29C 45/34; B29C 45/00; B29C 45/04; B29C 45/43; B33Y 70/00; B33Y 80/00; B29C 45/26

(52) U.S. Cl. CPC B29C 45/34; B29C 45/0001; B29C 45/04; B29K 2083/00; B33Y 70/00; B33Y 80/00; B29C 45/2608; B29C 45/43

(57) ABSTRACT

Provided is a liquid silicone molding die, including a first mold base, having at least one first molding zone and a feed hole on one side thereof and having a feeding mechanism coupled to the feed hole on the other side thereof, wherein the feeding mechanism is coupled to an injection machine to inject a raw material, and a heating element is provided around the first molding zone; and a second mold base, operatively facing or separating from the first mold base, corresponding to the side of the first mold base and correspondingly provided with a second molding zone, an injection channel, a sealing ring groove and a sealing ring.

### BACKGROUND OF THE INVENTION

### 1. Field of the Invention

The present disclosure relates to a liquid silicone molding die, and particularly relates to a structure that pumps air out of a mold and increases a vacuum inside the mold.

### 2. The Prior Arts

According to the optical products such as headlights, telescopes, projection lamps, projector spotlights, VR glasses, etc., since a lens is required to concentrate the light source to directivity or local illumination, the lens needs excellent transparency. The commonly used material thereof is polycarbonate (PC). However, the polycarbonate material has good light transmittance, but it has the disadvantage of being fragile, and fogging will occur after a long time of use, resulting in a problem of reduced transparency. At present, the electric vehicle market is booming due to the power saving factor. The light is changed to LED. Short-wave blue light of LED light causes yellowing and atomization of PC and poly(methylmethacrylate) (PMMA). The use of conventional halogen lamps consumes electricity and causes the battery life of electric vehicles to be shortened. Therefore, such optical products are gradually being replaced by silicone.

In general, the production of silicone requires the injection of liquid silicone into a conventional mold for heat curing and setting. However, when liquid silicone is injected into the mold, residual air inside the mold causes incomplete molding or bubbles. Therefore, the mold will be designed with an overflow channel to allow the gas to drain to the overflow channel, in order to endure the integrity of a finished product. In addition, in the process of clamping, vacuuming is also performed to reduce the pressure inside the mold, so that the liquid silicone can flow quickly.

However, since the liquid silicone is made up of two materials, chemical bubbles will be generated in the process of mixing the barrel of the injection machine. When the molds are combined, it is impossible to continue vacuuming the inside of the molds. The silicone containing chemical bubbles is injected into the molds, and the gas insides the molds cannot be removed. After heating and solidification, the finished product still has bubbles. The bubbles in the finished product will cause shadows or scattering of light, which will affect the lighting effect. Since liquid silicone is a high-priced raw material and cannot be recycled, this causes waste and loss of production costs. Therefore, how to provide a better molding die is one of the current important topics.

### SUMMARY OF THE INVENTION

In light of the foregoing problems, an objective of the present disclosure is to provide a liquid silicone molding die. A vacuum in a mold can be increased, so that there is no bubble inside a finished product, and the defective rate of the finished product is reduced.

In order to achieve the above objective, the present disclosure provides a liquid silicone molding die, including a first mold base, having at least one first molding zone and a feed hole on one side thereof and having a feeding mechanism coupled to the feed hole on the other side thereof, wherein the feeding mechanism is coupled to an injection machine to inject a raw material, and a heating element is provided around the first molding zone; and a second mold base, operatively facing or separating from the first mold base, corresponding to the side of the first mold base and correspondingly provided with a second molding zone, an injection channel, a sealing ring groove and a sealing ring, wherein the second molding zone is combined with the first molding zone to form a molding chamber; the injection channel is coupled to the feed hole and the molding chamber; the molding chamber is partially provided with a gas permeable module; the sealing ring groove is disposed around the second molding zone; the second mold base is provided with an exhaust passage; an exhaust hole and a vent hole are respectively formed at two ends of the exhaust passage; the exhaust hole corresponds to the gas permeable module; the vent hole is disposed on one side of the second mold base, and is coupled to an air suction device; the gas permeable module is made of a porous material; the porous material is filled with a plurality of pores; the gas permeable module is coupled to the exhaust hole; when the first mold base and the second mold base are combined, air inside the molding chamber is evacuated through a path formed by coupling the plurality of pores of the gas permeable module to the exhaust passage.

Preferably, the gas permeable module is disposed in the second molding zone.

Preferably, the gas permeable module is formed by three-dimensional printing or by processing with a gas permeable steel.

Preferably, the feeding mechanism comprises at least one shunt tube, the shunt tube is internally provided with a feeding channel coupled to the feed hole and the injection machine, and a cooling waterway is provided around the shunt tube.

Preferably, the present disclosure further comprises a barrier unit, disposed between the first mold base and the feeding mechanism, wherein the barrier unit has at least one insulation template.

Preferably, the sealing ring is disposed in the sealing ring groove, one side of the sealing ring is fitted to a bottom of the sealing ring groove, and another side of the sealing ring is attached to the first mold base in a state in which the second mold base is coupled to the first mold base.

Preferably, the first mold base is provided with a first groove, the first groove is provided with a first mold core, the first molding zone is disposed on the first mold core, the second mold base is proved with a second groove, the second groove is provided with a second mold core, and the second molding zone is disposed on the second mold core.

Preferably, when a finished product is formed in the molding chamber, and the first mold base is separated from the second mold based, the air is reversely blown by the air venting device through the exhaust passage, and is ejected from the plurality of pores of the gas permeable module to disengage the finished product form the molding chamber.

### BRIEF DESCRIPTION OF THE DRAWINGS

FIG. 1 is a schematic three-dimensional exploded diagram of a molding die according to a preferred embodiment of the present disclosure.

FIG. 2 is a three-dimensional schematic diagram of a first mold base according to the preferred embodiment of the present disclosure.

FIG. 3 is a three-dimensional schematic diagram of a second mold base according to the preferred embodiment of the present disclosure.

FIG. 4 is a cross-sectional diagram showing the molding die in a mold coupling state according to the preferred embodiment of the present disclosure.

FIG. 5 is a cross-sectional diagram taken along line A-A of FIG. 4 according to the preferred embodiment of the present disclosure.

FIG. 6 is a partially enlarged cross-sectional diagram showing FIG. 5 according to the preferred embodiment of the present disclosure.

### DETAILED DESCRIPTION OF THE PREFERRED EMBODIMENT

The detailed description of the present invention is provided in combination with the accompanying drawings.

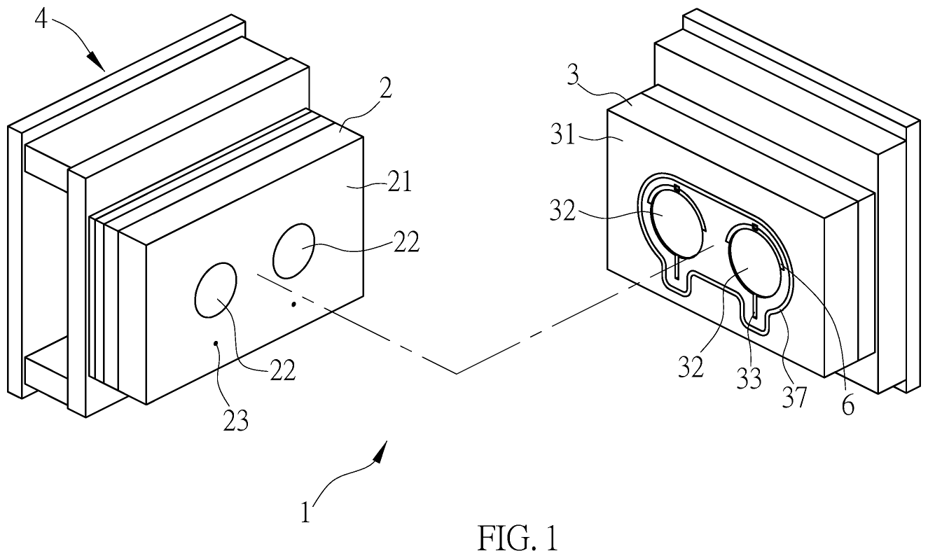

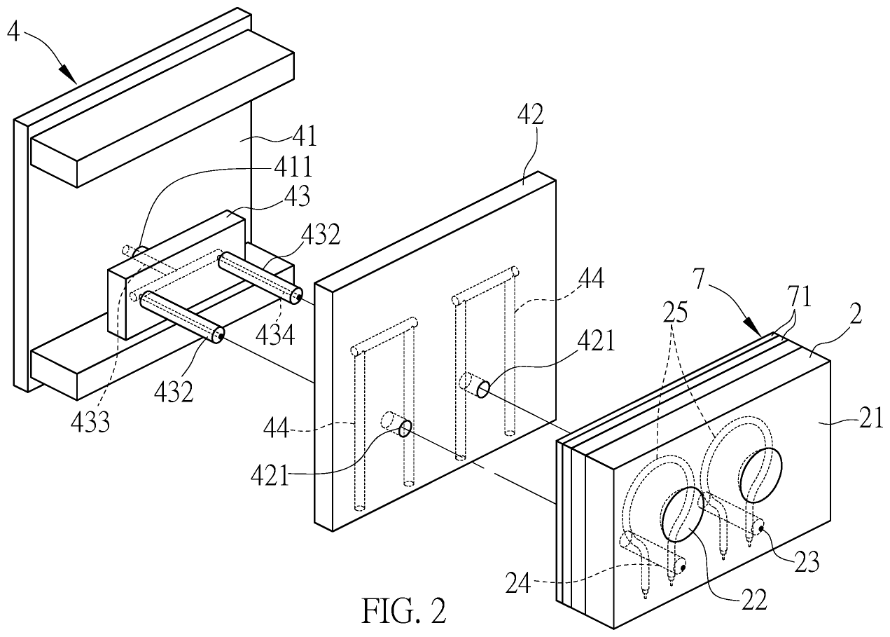

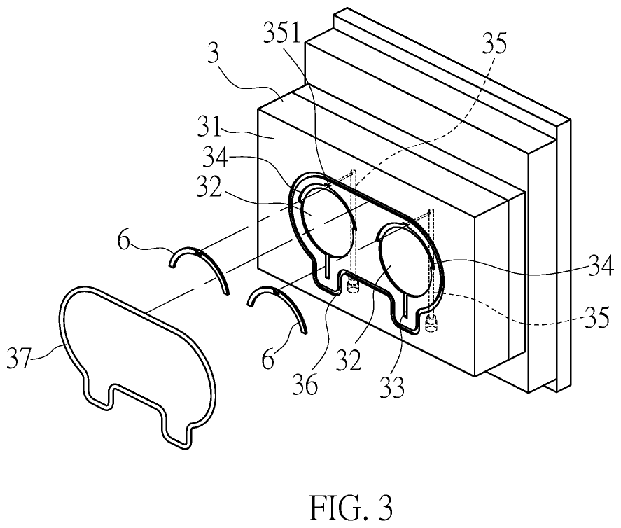

As shown in FIG. 1 to FIG. 6, a liquid silicone molding die 1 of the present disclosure mainly includes a first mold base 2 and a second mold base 3. The first mold base 2 and the second mold base 3 are operatively aligned or separated from one another.

A first matching face 21 is formed on one side of the first mold base 2. The first matching face 21 is provided with two first molding zones 22 and two feed holes 23. The present disclosure does not limit the number of the first molding zones 22 and the feed holes 23, and the number thereof must be at least one. The structure of the first molding zone 22 is not limited. The first molding zone 22 is exemplified by a hemispherical groove, which can be formed into a groove or a convex depending on the product. According to a preferred embodiment of the present disclosure, one side of each of the feed holes 23 is connected to a guide hole 24. The guide hole 24 has a larger aperture than the feed hole 23, and the guide hole 24 penetrates the thickness of the first mold base 2. The first mold base 2 is further provided with a heating element 25 around the first molding zone 22. In the preferred embodiment of the present disclosure, the first mold base 2 is composed of a plurality of plates, and the heating element 25 is sandwiched between two plates and corresponds to the periphery of the first molding zone 22. The present disclosure does not limit the aspect of the heating element 25. Any structure that can heat the first mold base 2 to maintain a preset temperature is within the scope of the present disclosure, and the drawings are shown by an electric heating tube.

Further, one side of the first mold base 2 facing away from the first matching face 21 is provided with a feeding mechanism 4, which comprises a first clamping plate 41, a second clamping plate 42 and a deflector 43. The first clamping plate 41 is provided with a first fixing hole 411 penetrating therethrough, and the second clamping plate 42 is provided with two second fixing holes 421. The deflector 43 is disposed between the first clamping plate 41 and the second clamping plate 42. The feed tube 431 is disposed on one side of the deflector 43 and is disposed through the first fixing hole 411 of the first clamping plate 41 for connection with an injection machine 5. Another side of the deflector 43 is provided with two shunt tubes 432. Each of the shunt tubes 432 is disposed through the second fixing hole 421 of the second clamping plate 42 and is disposed in the guide hole 24 of the first mold base 2.

A shunt channel 433 is disposed in the deflector 43. Each of the shunt tubes 432 is provided with a feeding channel 434. One end of each of the feeding channel 434 is connected to the shunt channel 433, and another end thereof is connected to the feed hole 23. One end of the shunt channel 433 extends through the feed tube 431 and is in communication with the injection machine 5. Moreover, in order to maintain the fluidity of the liquid silicone during the feeding process, a cooling waterway 44 is disposed around the shunt tube 432 in the second clamping plate 42. Cooling water can be circulated inside the cooling waterway 44 to maintain the temperature of the shunt tube 432, such that the heat of the shunt tube 432 can be avoided to affect the flowability of the internal liquid silicon. The present disclosure does not limit the distribution and number of the cooling waterways, and it is also possible to simultaneously provide a cooling waterway 44 in the deflector 43.

Since the liquid silicone is cured and shaped by heating, a barrier unit 7 is further disposed between the first mold base 2 and the second clamping plate 42 of the feeding mechanism 4, so that the feeding mechanism 4 is not affected by the heating element 25 provided by the first mold base 2. In the preferred embodiment of the present disclosure, the barrier unit 7 has two insulation templates 71, which may be materials such as superconducting plates or electric wood boards, etc., thereby isolating the temperature of the first mold base 2 from the feeding mechanism 4.

The second mold base 3 is provided with a second matching surface 31, and the second matching surface 31 is provided with two second molding zones 32 and two injection channels 33 spaced apart. The present disclosure does not limit the structure of the second molding zone 32. The second molding zone 32 is exemplified by a circular dish-shaped groove, which can be formed into a groove or a convex depending on the product. When the first mold base 2 is engaged with the second mold base 3, the second molding zone 32 is combined with the first molding zone 22 to form a molding chamber S. The injection channel 33 is connected to the feed hole 23 and the molding chamber S. Further, the molding chamber S is partially provided with a gas permeable module 6, which is formed by three-dimensional printing or a porous material formed by processing of a gas permeable steel material. The porous material enables the gas permeable 6 to have a plurality of pores. In the preferred embodiment of the present disclosure, the gas permeable module 6 is disposed in the second molding zone 32. Mainly, the second matching surface 32 is provided with an installation slot 34. The gas permeable module 6 is disposed in the installation slot 34 as part of the second molding zone 32. An exhaust passage 35 is further disposed inside the second mold base 3. An exhaust hole 351 and a vent hole 352 are respectively formed at two ends of the exhaust passage 35. The exhaust hole 351 corresponds to the gas permeable module 6, and is in communication with the gas permeable module 6. The vent hole 352 is disposed on one side of the second mold base 3 for connecting to an air venting device A.

In addition, the second mold base 3 is provided with a sealing ring groove 36 on the second matching surface 31. The sealing ring groove 36 is disposed around each of the second molding zones 32, and a sealing ring 37 is disposed in the sealing ring groove 36. One side of the sealing ring 37 is attached to the bottom of the sealing ring groove 36. In a state in which the second mold base 3 is engaged with the first mold base 2, another side of the sealing ring 37 is attached to the first matching surface 21 of the first mold base 2, so that each molding chamber S is kept in a sealed state.

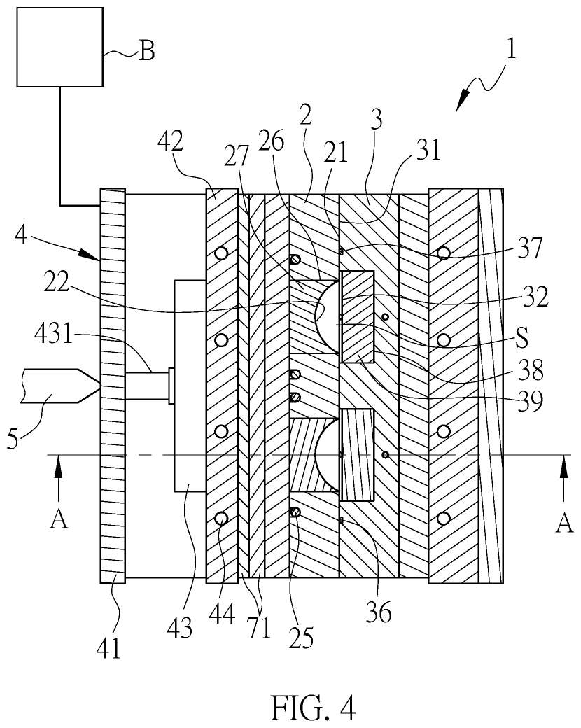

As shown in FIG. 4, the first mold base 2 is provided with two first grooves 26, and a first mold core 27 is disposed in each of the first grooves 26. The first molding zone 22 is disposed on the first mold core 27. The second mold base 3 is provided with two second grooves 38, and a second mold core 39 is disposed in the second groove 38. The second molding zone 32 is disposed on the second mold core 39. When the first molding zone 22 and the second molding zone 32 are worn out, only the first mold core 27 and the second mold core 39 may be replaced, without replacing the entire first mold base 2 and the second mold base 3.

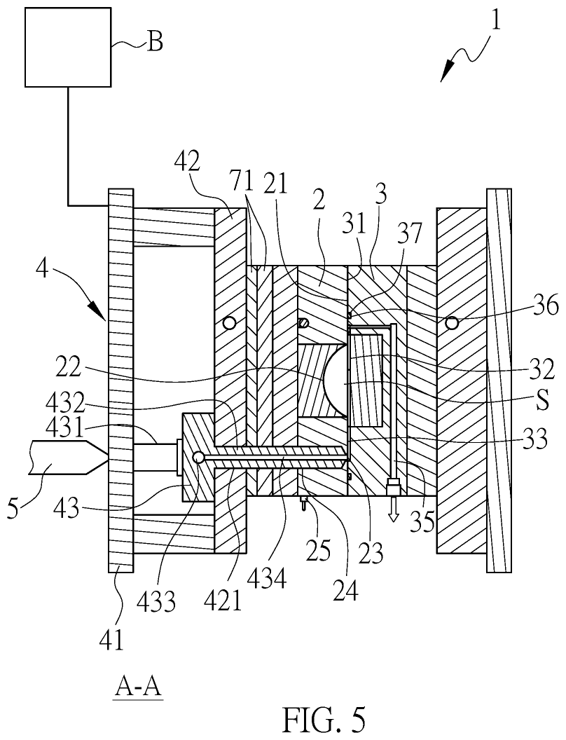

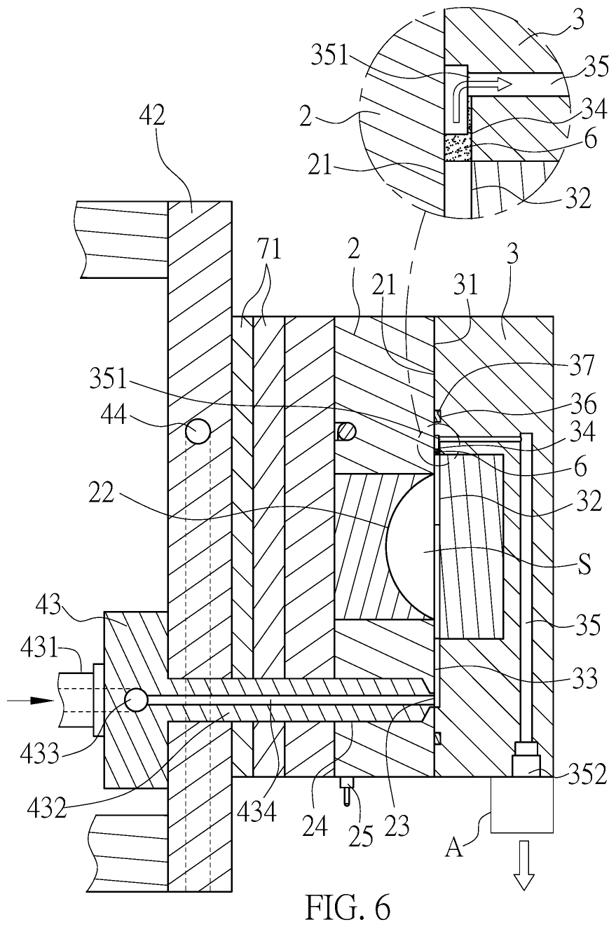

As shown in FIG. 6, when the first mold base 2 is engaged with the second mold based 3, the air venting device A extracts air in the molding chamber S via the exhaust passage 35, as indicated by a hollow arrow. Since the sealing ring 37 surrounds the molding chamber S, the molding chamber S can be ensured to be in a sealed state, and the internal vacuum can be maintained after the first mold base 2 is combined with the second mold based 3. The injection machine 5 simultaneously delivers the liquid silicone to the feed hole 23 via the shunt channel 433 and the feeding channel 434 of the feeding mechanism 4. Therefore, the liquid silicon is delivered to the molding chamber S through the injection channel 33 of the second mold base 3, in order to prevent the liquid silicone from blocking the pores of the gas permeable module 6. When the liquid silicone is injected to about half of the molding chamber S, the air venting device A stops pumping, so that the liquid silicone is gradually filled into the molding chamber S, and the chemical bubbles generated by the liquid silicone can be dissipated into the exhaust passage 35 by the pores of the gas permeable module 6. Further, the heat generated by the heating element 25 solidifies the liquid silicone in the mold chamber S to form a bubble-free finished product. As shown in FIGS. 4 and 5, the above-mentioned injection machine 5, the heating element 25 and the air venting device A are controlled by a controller B to control the program and operating time. Since the programming of the controller B will vary depending on different structures of a mold, it will not be described in detail.

Besides, during the demolding process in which the first mold base 2 and the second mold base 3 are separated from each other after the finished product is solidified, By the air venting device A, the exhaust passage 35 is reversely blown, and the air enters the molding chamber S through the plurality of the pores of the gas permeable module 6, thereby reducing the adhesion of the finished product to the molding chamber S, blowing the cured product away from the molding chamber S, and lowering the temperatures of the first mold base 2 and the second mold base 3. As such, the finished product can be smoothly separated from the first mold base 2 or the second mold base 3. In the next injection molding process, the liquid silicone can be injected into the first mold base 2 and the second mold base 2 under cold conditions, so that the silicone maintains a stable fluidity in the production of the next mold, and allows the finished product to be detached from the molding chamber S without the ad of a demolding device.

Compared to the prior art, the advantages of the present disclosure are as follows.

1. A gas permeable module is arranged in the molding chamber, so that air can still be extracted from the molding chamber after the first mold base and the second mold based are combined.

2. The chemical bubbles generated before the liquid silicone is heated and solidified can be dissipated by the gas permeable module when the first mold base and the second mold base are combined, so that the finished product has no bubble problem and the yield of finished products is improved.

3. Liquid silicone molding time is shorter than polycarbonate, thereby increasing productivity.

4. The air venting device can blow back the molding chamber to reduce the adhesion of the finished product to the molding chamber, thereby reducing the temperatures of the first mold base and the second mold base in order to maintain the stable fluidity of liquid silicone during the next injection.

5. The air is blown back by the air venting device, so that the solidified product can be automatically separated from the molding chamber without the aid of a demolding device.

Although the present disclosure has been described with reference to the preferred exemplary embodiments thereof, it is apparent to those skilled in the art that a variety of modifications and changes may be made without departing from the scope of the present disclosure which is intended to be defined by the appended claims.

What is claimed is:

1. A liquid silicone molding die, comprising:
a first mold base, having at least one first molding zone and a feed hole on one side thereof and having a feeding mechanism coupled to the feed hole on the other side thereof, wherein the feeding mechanism is coupled to an injection machine to inject a raw material, and a heating element is provided around the first molding zone; and
a second mold base, operatively facing or separating from the first mold base, corresponding to the side of the first mold base and correspondingly provided with a second molding zone, an injection channel, a sealing ring groove and a sealing ring, wherein the second molding zone is combined with the first molding zone to form a molding chamber; the injection channel is coupled to the feed hole and the molding chamber; the molding chamber is partially provided with a gas permeable module; the sealing ring groove is disposed around the second molding zone; the second mold base is provided with an exhaust passage; an exhaust hole and a vent hole are respectively formed at two ends of the exhaust passage; the exhaust hole corresponds to the gas permeable module; the vent hole is disposed on one side of the second mold base, and is coupled to an air suction device; the gas permeable module is made of a porous material; the porous material is filled with a plurality of pores; the gas permeable module is coupled to the exhaust hole; when the first mold base and the second mold base are combined, air inside the molding chamber is evacuated through a path formed by coupling the plurality of pores of the gas permeable module to the exhaust passage.

2. The liquid silicone molding die of claim 1, wherein the gas permeable module is disposed in the second molding zone.

3. The liquid silicone molding die of claim 1, wherein the gas permeable module is formed by three-dimensional printing or by processing with a gas permeable steel.

4. The liquid silicone molding die of claim 1, wherein the feeding mechanism comprises at least one shunt tube, the shunt tube is internally provided with a feeding channel coupled to the feed hole and the injection machine, and a cooling waterway is provided around the shunt tube.

5. The liquid silicone molding die of claim 1, further comprising a barrier unit, disposed between the first mold base and the feeding mechanism, wherein the barrier unit has at least one insulation template.

6. The liquid silicone molding die of claim 1, wherein the sealing ring is disposed in the sealing ring groove, one side of the sealing ring is fitted to a bottom of the sealing ring groove, and another side of the sealing ring is attached to the first mold base in a state in which the second mold base is coupled to the first mold base.

7. The liquid silicone molding die of claim 1, wherein the first mold base is provided with a first groove, the first groove is provided with a first mold core, the first molding zone is disposed on the first mold core, the second mold base is proved with a second groove, the second groove is provided with a second mold core, and the second molding zone is disposed on the second mold core.

8. The liquid silicone molding die of claim 1, wherein when a finished product is formed in the molding chamber, and the first mold base is separated from the second mold based, the air is reversely blown by the air venting device through the exhaust passage, and is ejected from the plurality of pores of the gas permeable module to disengage the finished product form the molding chamber.
